(19) United States
(12) Patent Application Publication
(10) Pub. No.: US 2019/0048991 A1
(43) Pub. Date: Feb. 14, 2019

(54) Hybrid Transmission Coolant Flow Management System

(71) Applicant: Ford Global Technologies, LLC, Dearborn, MI (US)

(72) Inventors: Dengfu Zhang, Northville, MI (US); Mark Steward, Ann Arbor, MI (US); William Riley, Warren, MI (US); Brian Richard Light, Flat Rock, MI (US)

(73) Assignee: Ford Global Technologies, LLC, Dearborn, MI (US)

(21) Appl. No.: 15/672,687

(22) Filed: Aug. 9, 2017

(51) Int. Cl. F16H 57/04; F16H 41/30; F15D 1/00

(52) U.S. Cl. CPC F16H 57/0423; F16H 41/30; F15D 1/0005; B60W 10/08; F16H 57/0424; F16H 57/0453; F16H 57/0472; F16H 57/0457

(57) ABSTRACT

A transmission assembly including a housing, an electric motor, and a baffle is provided. The housing may include first and second drainage channels. The electric motor may be disposed within the housing adjacent the drainage channels and a torque converter. The baffle may be disposed within the housing upon a housing inner surface, and may define an opening to the first and second drainage channels. The baffle may include a baffle flange sized for positioning adjacent the torque converter to minimize contact of oil within the housing to the torque converter. The housing may define first and second partition walls each partially extending over one of the first and second drainage channels. The baffle may further include first and second seal features each disposed at one of two baffle ends.

### TECHNICAL FIELD

This disclosure relates to a coolant flow management system for a vehicle hybrid transmission.

### BACKGROUND

Vehicle torque converters often operate in a dry environment. Torque converters of hybrid transmissions often operate in a wet environment. Packaging constraints between the torque converter and transmission may limit cooling oil drainage. For example, oil may accumulate around an electric motor and the torque converter. This oil accumulation may induce spin loss from the torque converter.

### SUMMARY

A transmission assembly includes a housing, an electric motor, and a baffle. The housing includes first and second drainage channels. The electric motor is disposed within the housing adjacent the drainage channels and a torque converter. The baffle is disposed within the housing upon a housing inner surface, defines an opening to the first and second drainage channels, and includes a baffle flange sized for positioning adjacent the torque converter to minimize contact of oil within the housing to the torque converter. The housing may define first and second partition walls each partially extending over one of the first and second drainage channels. The baffle may further include first and second seal features each disposed at one of two baffle ends. Each of the first and second seal features may be secured to the housing inner surface to prevent oil from accumulating between the baffle and the housing inner surface. The housing may further include first and second trenches. The baffle may define third and fourth trenches with the opening disposed therebetween and each sized for resting within one of the first and second trenches. The trenches may be arranged with one another to orient the opening to facilitate fluid communication between a housing cavity and the first and second drainage channels. The baffle may further include first and second caps each sized for securing to an end of one of the first and second drainage channels. The baffle may further include a baffle flap extending from the baffle flange at an angle based on a shape of the torque converter to influence oil to flow toward the opening and away from the torque converter. The assembly may further include a housing vent open to a cavity and defined by the housing to assist in maintaining pressure conditions of the cavity within a predetermined threshold.

A hybrid vehicle transmission assembly includes a housing and a baffle. The housing is for receiving a torque converter and an adjacent electric machine. The housing defines an inner surface having first and second partition walls each partially extending above one of two oil drainage channels. The baffle is disposed upon the inner surface beneath the electric machine and includes a drainage opening open to each of the two oil drainage channels. The baffle is arranged with the torque converter to direct oil introduced within the housing to the two oil drainage channels via the opening. The baffle may further include first and second seals each disposed at one of two baffle ends. The first and second seals may be sized for securing to the inner surface to prevent oil from accumulating between the baffle and the inner surface. The housing may define a substantially circular profile. The first and second seals may be radially spaced from one another at approximately 180 degrees relative to the profile. An oil distributor may be mounted to the housing for delivering oil within the housing. The baffle may further include a baffle flange extending from a baffle body at approximately ninety degrees and a baffle flap extending from the baffle flange. The baffle flange and the baffle flap may be oriented relative to the torque converter to prevent oil within the housing from contacting the torque converter. The baffle may be further arranged with the torque converter so the baffle flange and flap are located adjacent the torque converter to influence oil to travel toward the drainage opening. A housing vent may be located adjacent an oil distributor and open to a cavity defined by the inner surface of the housing to assist in maintaining pressure conditions of the cavity within a predetermined threshold.

A hybrid vehicle transmission assembly includes a housing and a baffle. The housing includes first and second drainage channels extending below a mount location for an electric motor and a torque converter. The baffle is disposed upon the mount location, defines an opening to the drainage channels, and includes a first seal located at one of two opposing baffle ends for securing to a housing inner surface to prevent oil from accumulating between the baffle and the housing inner surface. The housing may further include first and second trenches. The baffle defines third and fourth trenches with the opening disposed therebetween and each of the third and fourth trenches may be sized for resting within one of the first and second trenches. The trenches may be arranged with one another to orient the opening to facilitate fluid communication between a housing cavity and the first and second drainage channels. One of the first and second trenches may be arranged with the first seal to prevent oil from accumulating upon an inner surface of the housing therebetween. An oil distributor may be open to a cavity and adjacent a housing vent. The baffle may further include a second seal. The first seal and the second seal may each be located at one of the two opposing baffle ends. The housing may define a substantially circular profile. Each of the first seal and the second seal may be radially spaced from one another at approximately 180 degrees relative to the substantially circular profile.

### BRIEF DESCRIPTION OF THE DRAWINGS

FIG. 1 is a schematic diagram illustrating an example of a vehicle.

FIG. 2 is a perspective view of an example of a portion of a transmission assembly for a vehicle.

FIG. 3 is a perspective view of the transmission assembly of FIG. 2 illustrating an example of operational oil distribution.

FIG. 4 is a perspective view of an example of a portion of a transmission housing of a transmission assembly.

FIG. 5 is another perspective view of the portion of the transmission housing of FIG. 4.

FIG. 6 is a perspective view of the portion of the transmission housing of FIG. 4 illustrating an example of a baffle component.

FIG. 7 is a perspective view of the baffle component of FIG. 6.

FIG. 8 is another perspective view of the baffle component of FIG. 6.

FIG. 9 is a front view, in cross-section, of a portion of the transmission assembly of FIG. 2.

FIG. 10 is a perspective view of an example of a transmission assembly including the transmission housing of FIG. 4 illustrating an example of operational oil distribution.

FIG. 11 is a graph comparing spin losses due to oil accumulation within the transmission assembly of FIGS. 2 and 3 and the transmission assembly of FIGS. 4 through 10.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

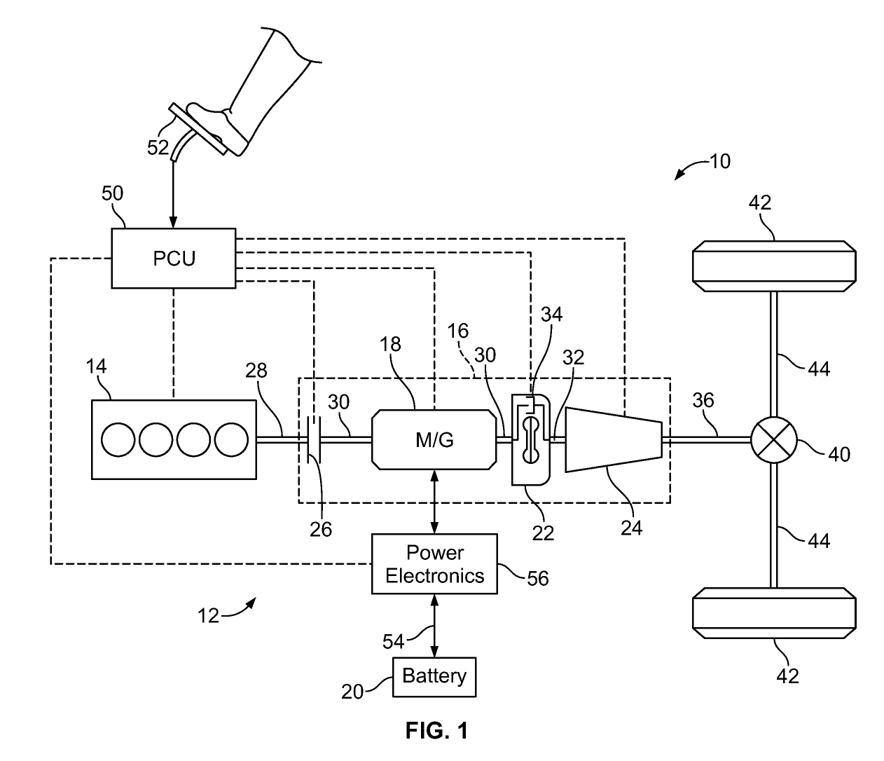

FIG. 1 is a schematic diagram illustrating an example of a hybrid electric vehicle (HEV) referred to as a vehicle 10. FIG. 1 illustrates representative relationships among the components. Physical placement and orientation of the components within the vehicle may vary. The vehicle 10 includes a powertrain 12. The powertrain 12 includes an engine 14 that drives a transmission 16, which may be referred to as a hybrid transmission. As will be described in further detail below, transmission 16 includes an electric machine such as an electric motor/generator (M/G) 18, an associated traction battery 20, a torque converter 22, and a multiple step-ratio automatic transmission, or gearbox 24.

The engine 14 and the M/G 18 are both drive sources for the vehicle 10. The engine 14 generally represents a power source that may include an internal combustion engine such as a gasoline, diesel, or natural gas powered engine, or a fuel cell. The engine 14 generates an engine power and corresponding engine torque that is supplied to the M/G 18 when a disconnect clutch 26 between the engine 14 and the M/G 18 is at least partially engaged. The M/G 18 may be implemented by any one of a plurality of types of electric machines. For example, M/G 18 may be a permanent magnet synchronous motor. Power electronics condition direct current (DC) power provided by the traction battery 20 to the requirements of the M/G 18, as will be described below. For example, power electronics may provide three phase alternating current (AC) to the M/G 18.

When the disconnect clutch 26 is at least partially engaged, power flow from the engine 14 to the M/G 18 or from the M/G 18 to the engine 14 is possible. For example, the disconnect clutch 26 may be engaged and M/G 18 may operate as a generator to convert rotational energy provided by a crankshaft 28 and M/G shaft 30 into electrical energy to be stored in the traction battery 20. The disconnect clutch 26 can also be disengaged to isolate the engine 14 from the remainder of the powertrain 12 such that the M/G 18 can act as the sole drive source for the vehicle 10. Shaft 30 extends through the M/G 18. The M/G 18 is continuously drivably connected to the shaft 30, whereas the engine 14 is drivably connected to the shaft 30 only when the disconnect clutch 26 is at least partially engaged.

The M/G 18 is connected to the torque converter 22 via shaft 30. The torque converter 22 is therefore connected to the engine 14 when the disconnect clutch 26 is at least partially engaged. The torque converter 22 includes an impeller fixed to M/G shaft 30 and a turbine fixed to a transmission input shaft 32. The torque converter 22 thus provides a hydraulic coupling between shaft 30 and transmission input shaft 32. The torque converter 22 transmits power from the impeller to the turbine when the impeller rotates faster than the turbine. The magnitude of the turbine torque and impeller torque generally depend upon the relative speeds. When the ratio of impeller speed to turbine speed is sufficiently high, the turbine torque is a multiple of the impeller torque. During operation, oil is introduced assist in managing thermal conditions of the M/G 18.

A torque converter bypass clutch 34 may also be provided that, when engaged, frictionally or mechanically couples the impeller and the turbine of the torque converter 22, permitting more efficient power transfer. The torque converter bypass clutch 34 may be operated as a launch clutch to provide smooth vehicle launch. Alternatively, or in combination, a launch clutch similar to disconnect clutch 26 may be provided between the M/G 18 and gearbox 24 for applications that do not include a torque converter 22 or a torque converter bypass clutch 34. In some applications, disconnect clutch 26 is generally referred to as an upstream clutch and launch clutch 34 (which may be a torque converter bypass clutch) is generally referred to as a downstream clutch.

The gearbox 24 may include gear sets (not shown) that are selectively placed in different gear ratios by selective engagement of friction elements such as clutches and brakes (not shown) to establish the desired multiple discrete or step drive ratios. The friction elements are controllable through a shift schedule that connects and disconnects certain elements of the gear sets to control the ratio between a transmission output shaft 36 and the transmission input shaft 32. The gearbox 24 is automatically shifted from one ratio to another based on various vehicle and ambient operating conditions by an associated controller. The gearbox 24 then provides powertrain output torque to output shaft 36.

It should be understood that the hydraulically controlled gearbox 24 used with a torque converter 22 is but one example of a gearbox or transmission arrangement; any multiple ratio gearbox that accepts input torque(s) from an engine and/or a motor and then provides torque to an output shaft at the different ratios is acceptable for use with embodiments of the present disclosure. For example, gearbox 24 may be implemented by an automated mechanical (or manual) transmission (AMT) that includes one or more servo motors to translate/rotate shift forks along a shift rail to select a desired gear ratio.

As shown in the representative embodiment of FIG. 1, the output shaft 36 is connected to a differential 40. The differential 40 drives a pair of wheels 42 via respective axles 44 connected to the differential 40. The differential transmits approximately equal torque to each wheel 42 while permitting slight speed differences such as when the vehicle turns a corner. Different types of differentials or similar devices may be used to distribute torque from the powertrain to one or more wheels. In some applications, torque distribution may vary depending on the particular operating mode or condition.

The powertrain 12 further includes an associated controller 50 such as a powertrain control unit (PCU). While illustrated as one controller, the controller 50 may be part of a larger control system and may be controlled by various other controllers throughout the vehicle 10, such as a vehicle system controller (VSC). It should therefore be understood that the controller 50 and one or more other controllers can collectively be referred to as a “controller” that controls various actuators in response to signals from various sensors to control functions such as starting/stopping engine 14, operating M/G 18 to provide wheel torque or charge the traction battery 20, select or schedule transmission shifts, etc. Controller 50 may include a microprocessor or central processing unit (CPU) in communication with various types of computer readable storage devices or media.

The controller communicates with various engine/vehicle sensors and actuators via an input/output (I/O) interface that may be implemented as a single integrated interface that provides various raw data or signal conditioning, processing, and/or conversion, short-circuit protection, and the like. Alternatively, one or more dedicated hardware or firmware chips may be used to condition and process particular signals before being supplied to the CPU. Controller 50 may communicate signals to and/or from engine 14, disconnect clutch 26, M/G 18, launch clutch 34, transmission gearbox 24, and power electronics 56. Representative examples of parameters, systems, and/or components that may be directly or indirectly actuated using control logic executed by the controller include fuel injection timing, rate, and duration, throttle valve position, spark plug ignition timing (for spark-ignition engines), intake/exhaust valve timing and duration, front-end accessory drive (FEAD) components such as an alternator, air conditioning compressor, battery charging, regenerative braking, M/G operation, clutch pressures for disconnect clutch 26, launch clutch 34, and transmission gearbox 24, and the like.

The control logic may be implemented in software executed by a microprocessor-based vehicle, engine, and/or powertrain controller, such as the controller 50. When implemented in software, the control logic may be provided in one or more computer-readable storage devices or media having stored data representing code or instructions executed by a computer to control the vehicle or its subsystems.

An accelerator pedal 52 is used by the driver of the vehicle to provide a demanded torque, power, or drive command to propel the vehicle. In general, depressing and releasing the pedal 52 generates an accelerator pedal position signal that may be interpreted by the controller 50 as a demand for increased power or decreased power, respectively. Based at least upon input from the pedal, the controller 50 commands torque from the engine 14 and/or the M/G 18. The controller 50 also controls the timing of gear shifts within the gearbox 24, as well as engagement or disengagement of the disconnect clutch 26 and the torque converter bypass clutch 34. Like the disconnect clutch 26, the torque converter bypass clutch 34 can be modulated across a range between the engaged and disengaged positions. This produces a variable slip in the torque converter 22 in addition to the variable slip produced by the hydrodynamic coupling between the impeller and the turbine. Alternatively, the torque converter bypass clutch 34 may be operated as locked or open without using a modulated operating mode depending on the particular application.

To drive the vehicle 10 with the engine 14, the disconnect clutch 26 is at least partially engaged to transfer at least a portion of the engine torque through the disconnect clutch 26 to the M/G 18, and then from the M/G 18 through the torque converter 22 and gearbox 24. When the engine 14 alone provides the torque necessary to propel the vehicle, this operation mode may be referred to as the “engine mode,” “engine-only mode,” or “mechanical mode.”

The M/G 18 may assist the engine 14 by providing additional power to turn the shaft 30. This operation mode may be referred to as a “hybrid mode,” an “engine-motor mode,” or an “electric-assist mode.”

To drive the vehicle with the M/G 18 as the sole power source, the power flow remains the same except the disconnect clutch 26 isolates the engine 14 from the remainder of the powertrain 12. Combustion in the engine 14 may be disabled or otherwise OFF during this time to conserve fuel. The traction battery 20 transmits stored electrical energy through wiring 54 to power electronics 56 that may include an inverter, for example. The power electronics 56 convert DC voltage from the traction battery 20 into AC voltage to be used by the M/G 18. The controller 50 commands the power electronics 56 to convert voltage from the traction battery 20 to an AC voltage provided to the M/G 18 to provide positive or negative torque to the shaft 30. This operation mode may be referred to as an “electric-only mode,” “electric vehicle mode,” or “motor mode.”

In any mode of operation, the M/G 18 may act as a motor and provide a driving force for the powertrain 12. Alternatively, the M/G 18 may act as a generator and convert kinetic energy from the powertrain 12 into electric energy to be stored in the traction battery 20. The M/G 18 may act as a generator while the engine 14 is providing propulsion power for the vehicle 10, for example. The M/G 18 may additionally act as a generator during times of regenerative braking in which rotational energy from spinning wheels 42 is transferred back through the gearbox 24 and is converted into electrical energy for storage in the traction battery 20.

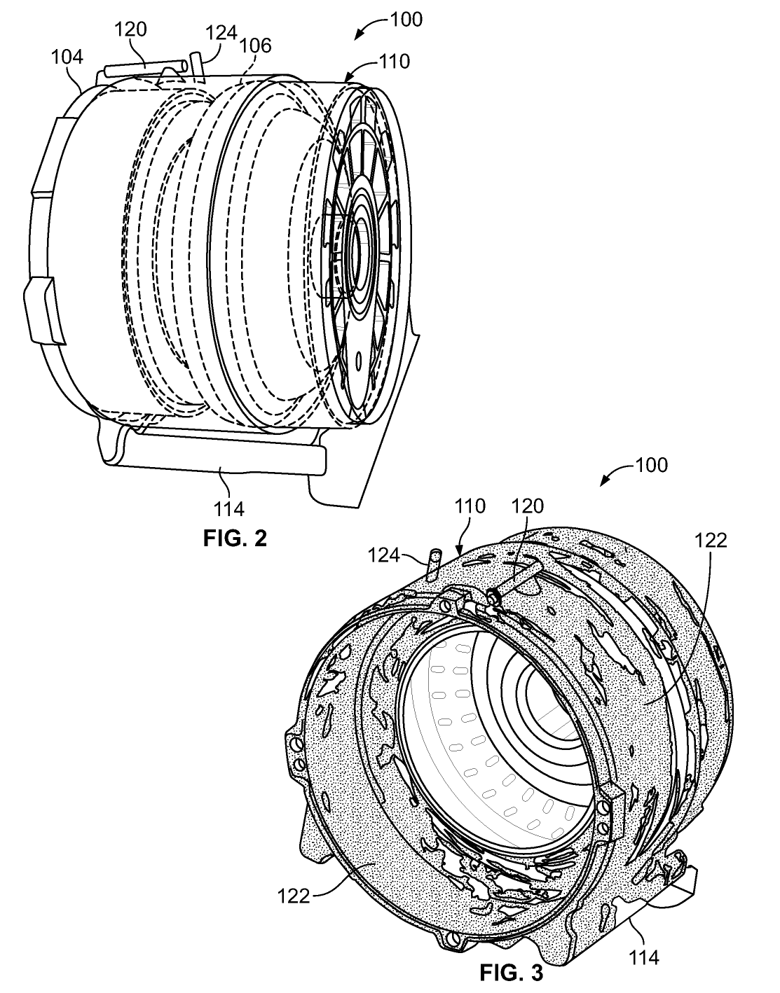

FIG. 2 is a perspective view of a previously known example of a portion of a vehicle transmission assembly, referred to as a transmission assembly 100 herein. The transmission assembly 100 includes an electric motor 104 and a torque converter 106. The electric motor 104 and the torque converter 106 are each disposed within a cavity of a transmission housing 110. The electric motor 104 operates as a motor to power the vehicle and vehicle components. The torque converter 106 operates as a fluid coupler to allow an engine to spin somewhat independently of a transmission. The transmission housing 110 defines a drainage channel 114 in fluid communication with the cavity of the transmission housing 110. An oil distributor 120 distributes coolant into the cavity of the transmission housing to cool the electric motor 104 during operation.

FIG. 3 is a perspective view illustrating an example of oil accumulation within the transmission housing 110 after approximately five seconds with the torque converter 106 rotating at approximately 2000 rpm. During operation, oil is pumped into the transmission housing 110 to assist in managing thermal conditions of components therein. This oil accumulates in locations that hinder performance of components of the transmission assembly 100. The electric motor 104 is removed in FIG. 3 to more clearly show oil accumulation throughout the cavity of the transmission housing 110. Oil accumulation is represented by coating 122. As shown, oil accumulates throughout the cavity, upon an inner surface of the transmission housing 110, and upon the torque converter 106 instead of exiting via the drainage channel 114 in a desirable fashion. Further, oil may accumulate in a housing vent 124. This oil accumulation negatively influences performance of the torque converter 106 and may cause spin losses, for example, of approximately 3.1 Nm at 2000 rpm. An improvement to an oil drainage system may assist in minimizing or eliminating the oil accumulation issue within the transmission housing 110.

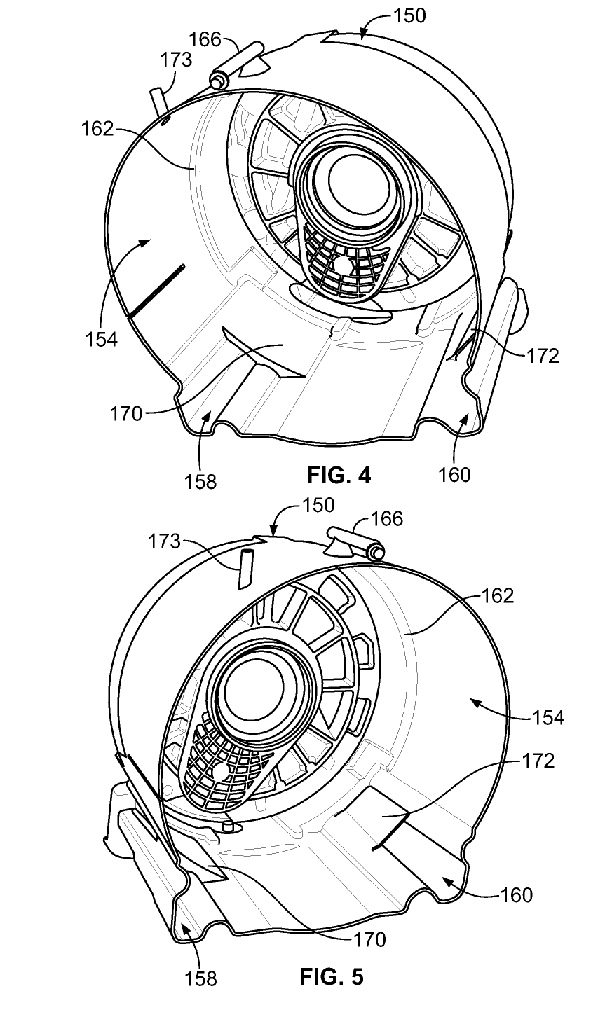

FIGS. 4 and 5 are perspective views of an example of a portion of a transmission housing, generally referred to as a transmission housing 150. The transmission housing 150 operates with other components to provide an improved oil drainage system in comparison to the transmission housing 110 shown in FIGS. 2 and 3. For example, the transmission housing 150 defines a cavity 154, a first drainage channel 158, a second drainage channel 160, and a lip 162. An oil distributor 166 is mounted to the housing to deliver oil to the cavity 154. A first partition wall 170 may extend over a portion of the first drainage channel 158 and a second partition wall 172 may extend over a portion of the second drainage channel 160. It is contemplated that alternative embodiments having different packaging constraints may or may not include one or more partition walls. A housing vent 173 may assist in maintaining pressure conditions of the cavity 154 within a predetermined threshold. The transmission housing 150 is sized to receive the electric motor and a torque converter (not shown in FIGS. 4 and 5). Oil distributed to the cavity 154 assists in cooling the electric motor during operation as further described herein.

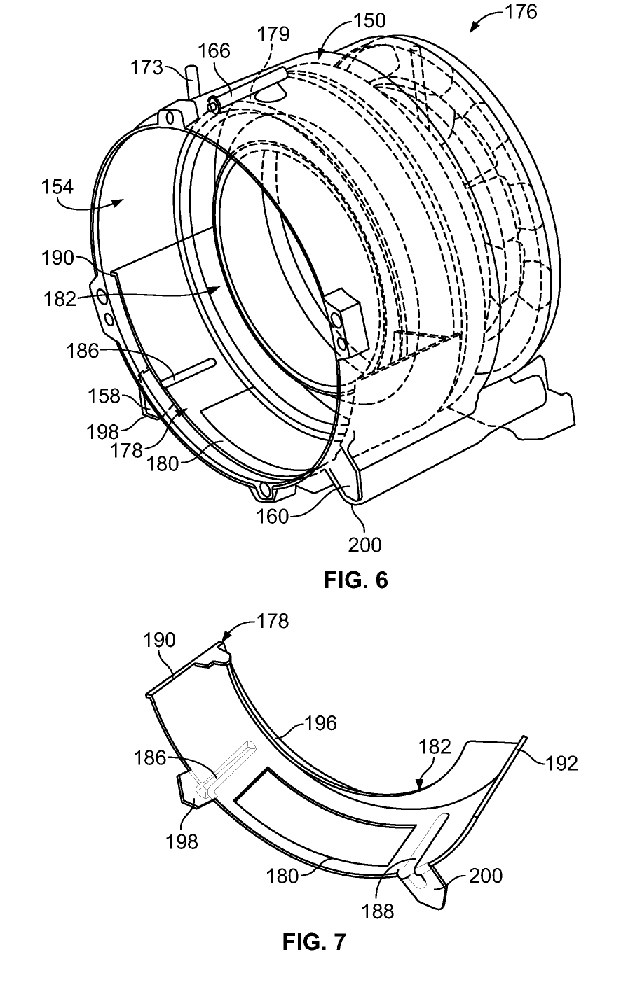

FIG. 6 is a perspective view of a portion of a transmission assembly 176 including the transmission housing 150 of FIGS. 4 and 5 shown with additional components mounted therein. A baffle 178 is mounted within the cavity 154 to an inner surface of the transmission housing 150. In one example the baffle 178 may be of a thermoplastic material. A torque converter 179 is shown mounted adjacent the baffle 178. An electric motor (not shown) may be mounted above the baffle 178 and adjacent the torque converter 179. The baffle 178 includes a drainage opening 180 and a baffle flange 182. The drainage opening 180 is oriented for fluid communication with the first drainage channel 158 and the second drainage channel 160. For example, oil that enters the transmission housing 110 via the oil distributor 166 may be influenced to travel to the drainage opening 180 and then the first drainage channel 158 and the second drainage channel 160.

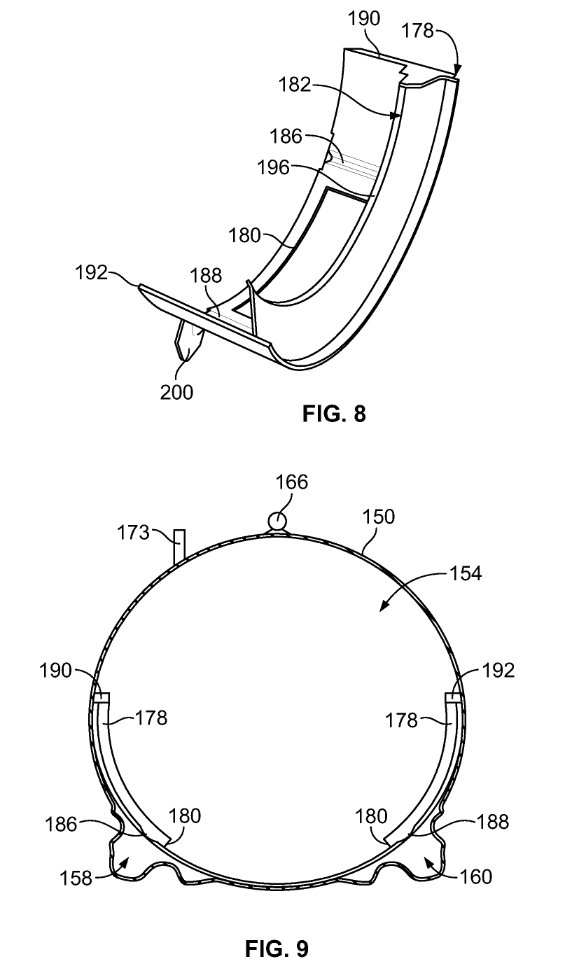

FIGS. 7 and 8 show further detail of the baffle 178. The baffle 178 may include a first trench 186 and a second trench 188 each located on opposing sides of the drainage opening 180. Each of the first trench 186 and the second trench 188 may be sized to sit within a similarly sized trench defined by the transmission housing 150 to assist in orienting the baffle 178 within the transmission housing 150.

The baffle 178 may include a first seal 190 and a second seal 192 each located on opposing side of the drainage opening 180. The first seal 190 may be arranged with the first trench 186 to prevent oil from accumulating upon the inner surface of the transmission housing 150 therebetween and the second seal 192 may be arranged with the second trench 188 to prevent oil from accumulating upon the inner surface of the transmission housing 150 therebetween. Each of the first seal 190 and the second seal 192 may be located at opposing ends of the baffle 178 and each may be sized for securing to the inner surface of the transmission housing 150 to prevent oil from accumulating between the baffle 178 and the inner surface. Each of the first seal 190 and the second seal 192 assist in preventing oil from traveling between the baffle 178 and the transmission housing 150 and assist in influencing oil to travel to the drainage opening 180. In one example, the first seal 190 and the second seal 192 may be radially spaced from one another at approximately 180 degrees relative to a circular profile defined by the transmission housing 150. In another embodiment, the baffle 178 may include only one of the first seal 190 and the second seal 192.

The baffle flange 182 is sized for being located adjacent the torque converter 179 such that oil entering the cavity 154 via the oil distributor 166 is prevented or minimized from contacting the torque converter 179. It is contemplated that the baffle flange 182 may extend about the cavity 154 three-hundred-sixty degrees or less. A flap 196 may extend from the baffle flange 182 at an angle based on a shape of the torque converter 179 to promote a seal relationship therebetween. The baffle flange 182 and the flap 196 may be sized to rest upon or adjacent the torque converter 179 to prevent oil introduced within the transmission housing 150 from contacting the torque converter 179. The baffle 178 may include a first cap 198 and a second cap 200. Each of the first cap 198 and the second cap 200 may provide a surface for securing to the transmission housing 150 via a fastener. The first cap 198 may provide a cap to seal the first drainage channel 158 and the second cap 200 may provide a cap to seal the second drainage channel 160.

FIG. 9 is a front view, in cross-section, illustrating a fluid path for oil from the oil distributor 166 to the first drainage channel 158 and the second drainage channel 160. For example, oil may enter the cavity 154 of the transmission housing 150 via the oil distributor 166. The oil may then be influenced toward the drainage opening 180 by the baffle 178. The oil may then enter the first drainage channel 158 or the second drainage channel 160. Inclusion of two separate drainage channels provides oil drainage benefits of the transmission assembly 176 in comparison to a single drainage channel 114 used in the transmission assembly 100. Additionally, inclusion of the baffle flange 182, the first seal 190, and the second seal 192 influences oil to travel toward the drainage opening 180 instead of toward the torque converter 179 to improve oil drainage characteristics of the transmission assembly 176.

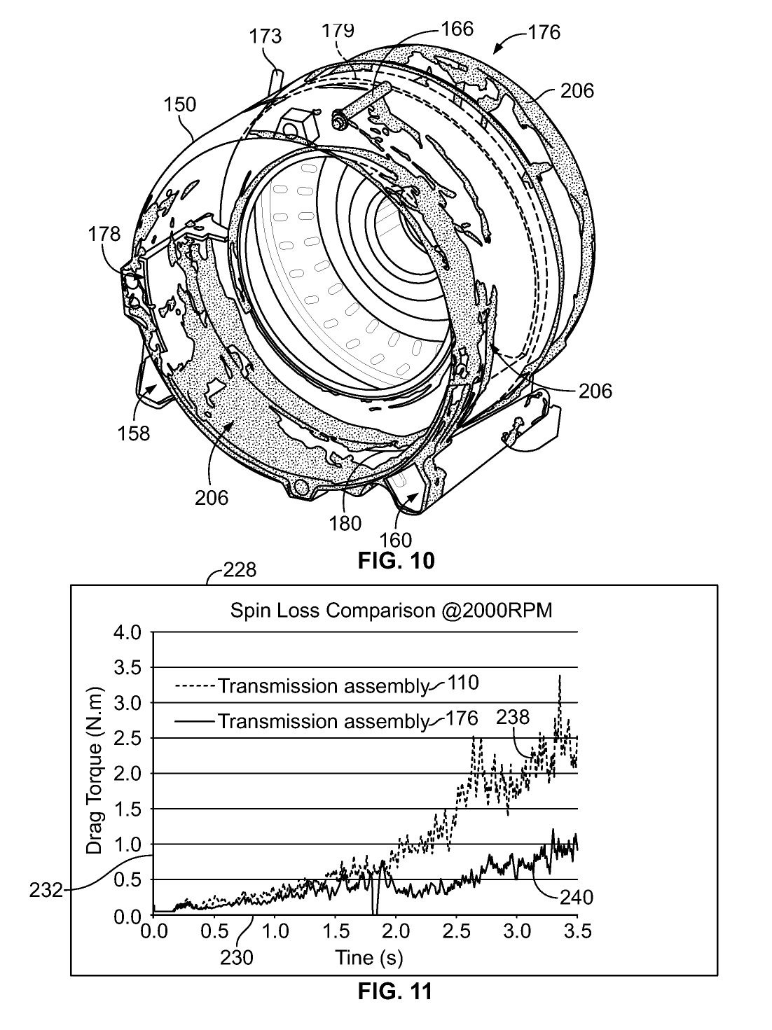

FIG. 10 is a perspective view of a portion of the transmission assembly 176 illustrating an example of oil accumulation within the transmission housing 150 after approximately five seconds with the torque converter 179 rotating at approximately 2000 rpm. The electric motor is not shown in FIG. 10 to more clearly show oil accumulation. Oil accumulation is represented by coating 206. As shown in FIG. 10, an addition of the baffle 178 provides for more efficient oil drainage and less oil accumulation within the transmission housing 150 in comparison to a system of the transmission housing 110. For example, FIG. 10 shows almost zero oil accumulation upon the torque converter 179 and within the housing vent 173. FIG. 10 also shows oil accumulation upon the inner surface of the transmission 150 as significantly less than oil accumulation upon an inner surface of the transmission housing 110.

FIG. 11 is a graph 228 illustrating an example of a comparison of torque converter spin loss between the transmission assembly 100 and the transmission assembly 176 due to oil accumulation within the respective transmission housing. X-axis 230 represents time and Y-axis 232 represents drag torque in Nm. Line 238 represents spin loss of the torque converter 106 of the transmission assembly 100 at a torque converter operating condition of 2000 rpm. Line 240 represents spin loss of the torque converter 179 of the transmission assembly 176 at a torque converter operating condition of 2000 rpm.

As shown in the graph 228, the transmission assembly 176 operates with less drag torque at 2000 rpm in comparison to the transmission assembly 100. This improvement in drag torque is due to inclusion of the baffle 178 to improve oil flow within the transmission housing 150 and due to inclusion of the first drainage channel 158 and the second drainage channel 160.

While various embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to marketability, appearance, consistency, robustness, customer acceptability, reliability, accuracy, etc. As such, embodiments described as less desirable than other embodiments or prior art implementations with respect to one or more characteristics are not outside the scope of the disclosure and can be desirable for particular applications.

What is claimed is:

1. A transmission assembly comprising:
a housing including first and second drainage channels;
an electric motor disposed within the housing adjacent the drainage channels and a torque converter; and
a baffle disposed within the housing upon a housing inner surface, defining an opening to the first and second drainage channels, and including a baffle flange sized for positioning adjacent the torque converter to minimize contact of oil within the housing to the torque converter.

2. The assembly of claim 1, wherein the housing defines first and second partition walls each partially extending over one of the first and second drainage channels.

3. The assembly of claim 1, wherein the baffle further includes first and second seal features each disposed at one of two baffle ends, and wherein each of the first and second seal features are secured to the housing inner surface to prevent oil from accumulating between the baffle and the housing inner surface.

4. The assembly of claim 1, wherein the housing further includes first and second trenches, wherein the baffle defines third and fourth trenches with the opening disposed therebetween and each sized for resting within one of the first and second trenches, and wherein the trenches are arranged with one another to orient the opening to facilitate fluid communication between a housing cavity and the first and second drainage channels.

5. The assembly of claim 1, wherein the baffle further includes first and second caps each sized for securing to an end of one of the first and second drainage channels.

6. The assembly of claim 1, wherein the baffle further includes a baffle flap extending from the baffle flange at an angle based on a shape of the torque converter to influence oil to flow toward the opening and away from the torque converter.

7. The assembly of claim 1 further comprising a housing vent open to a cavity defined by the housing to assist in maintaining pressure conditions of the cavity within a predetermined threshold.

8. A hybrid vehicle transmission assembly comprising:
a housing for receiving a torque converter and an adjacent electric machine and defining an inner surface having first and second partition walls each partially extending above one of two oil drainage channels, and
a baffle disposed upon the inner surface beneath the electric machine and including a drainage opening open to each of the two oil drainage channels,
wherein the baffle is arranged with the torque converter to direct oil introduced within the housing to the two oil drainage channels via the opening.

9. The assembly of claim 8, wherein the baffle further includes first and second seals each disposed at one of two baffle ends, and wherein the first and second seals are sized for securing to the inner surface to prevent oil from accumulating between the baffle and the inner surface.

10. The assembly of claim 9, wherein the housing defines a substantially circular profile, and wherein the first and second seals are radially spaced from one another at approximately 180 degrees relative to the profile.

11. The assembly of claim 8 further comprising an oil distributor mounted to the housing for delivering oil within the housing.

12. The assembly of claim 8, wherein the baffle further includes a baffle flange extending from a baffle body at approximately ninety degrees and a baffle flap extending from the baffle flange, and wherein the baffle flange and the baffle flap are oriented relative to the torque converter to prevent oil within the housing from contacting the torque converter.

13. The assembly of claim 12, wherein the baffle is further arranged with the torque converter so the baffle flange and flap are located adjacent the torque converter to influence oil to travel toward the drainage opening.

14. The assembly of claim 8 further comprising a housing vent located adjacent an oil distributor and open to a cavity defined by the inner surface of the housing to assist in maintaining pressure conditions of the cavity within a predetermined threshold.

15. A hybrid vehicle transmission assembly comprising:
a housing including first and second drainage channels extending below a mount location for an electric motor and a torque converter; and
a baffle disposed upon the mount location, defining an opening to the drainage channels, and including a first seal located at one of two opposing baffle ends for securing to a housing inner surface to prevent oil from accumulating between the baffle and the housing inner surface.

16. The assembly of claim 15, wherein the housing further includes first and second trenches, wherein the baffle defines third and fourth trenches with the opening disposed therebetween and each of the third and fourth trenches sized for resting within one of the first and second trenches, and wherein the trenches are arranged with one another to orient the opening to facilitate fluid communication between a housing cavity and the first and second drainage channels.

17. The assembly of claim 16, wherein one of the first and second trenches is arranged with the first seal to prevent oil from accumulating upon an inner surface of the housing therebetween.

18. The assembly of claim 15 further comprising an oil distributor open to a cavity and adjacent a housing vent.

19. The assembly of claim 15 further comprising a second seal, wherein the first seal and the second seal are each located at one of the two opposing baffle ends.

20. The assembly of claim 19, wherein the housing defines a substantially circular profile, and wherein each of the first seal and the second seal are radially spaced from one another at approximately 180 degrees relative to the substantially circular profile.
